(19) United States
(12) Patent Application Publication
(10) Pub. No.: US 2014/0360527 A1
(43) Pub. Date: Dec. 11, 2014

(54) Multi-Functional Klassic Toothbrush

(71) Applicant: Angela Thompson, Tampa, FL (US)

(72) Inventor: Angela Thompson, Tampa, FL (US)

(21) Appl. No.: 14/285,598

(22) Filed: May 22, 2014

Related U.S. Application Data
(60) Provisional application No. 61/826,423, filed on May 22, 2013.

(51) Int. Cl. A61C 17/22; A61C 17/02; A61C 15/04

(52) U.S. Cl. CPC A61C 17/227; A61C 15/043; A61C 17/0202; A61C 17/221
USPC 132/309

(57) ABSTRACT

The Multi-Functional Klassic Toothbrush is a compact, all in one system for maintaining a healthy dental hygiene on a daily basis. Incorporated within the unit is a vibrating replaceable toothbrush head, where toothpaste is electrically funneled onto the bristles. It also includes a tongue-scraper, a refillable reservoir of mouthwash and a replaceable cartridge of dental floss.

### CLAIM OF PRIORITY

This patent application claims priority under 35 USC 119 (e) (1) from U.S. Provisional Patent Application Ser. No. 61/826,423 filed May 22, 2013, of common inventorship herewith entitled, “Multi Functional Klassic Toothbrush.”

### FIELD OF THE INVENTION

The present invention pertains to the field of dental hygiene, and more specifically to the field of electric toothbrushes.

### BACKGROUND OF THE INVENTION

The prior art has put forth several designs for electric toothbrushes. Among these are:

US Patent 2011/0136081 to AnnMarie Micali describes a battery or otherwise electrically powered toothbrush with a dual purpose to effectively clean both teeth and gums. The toothbrush includes a handle and a removable brush head. The bristles on the brush head are designed to roll over the teeth and gums. There is a switch on the handle that allows the user to change the bristle direction of rotation. When brushing the upper teeth and gums, the head rolls downwardly. When brushing the lower teeth and gums, the head rolls upwardly. The back teeth's chewing surface is brushable in either direction. There may be two sets of bristles on the brush head. The first set contains long and soft bristles for massaging. The second set contains short and soft bristles for cleaning. There is an optional cylindrical compartment on the handle for either mouthwash or a non sugar reward for children.

US Patent 2006/0210352 to Lonnie Clark describes an electric toothpaste dispensing toothbrush mechanism with integral toothbrushes and toothpaste. It is the first integration to be completely automatic and works with electric toothbrushes at the touch of a button. It uses a gear reduction system to use the same motor to turn both the plunger shaft and the shaft meant to vibrate the bristles of the toothbrush head. This rotation causes the plunger inside the cartridge of toothpaste to rise and push toothpaste out of the toothbrush head for the user. The toothpaste reservoir contains enough toothpaste for preferably a month so that the user may change bristle heads on a regular basis as well. As such, the toothpaste cartridge and brush head along with the upper half parts are totally interchangeable.

U.S. Pat. No. 6,331,088 to Zena Elizabeth Owens describes a toothbrush with multiple pumping systems including a head portion having three rows of a plurality of outlet ports formed therein. The head portion has a plurality of bristles secured thereto. An elongated handle portion removably couples with the head portion. The handle portion has a hollow interior in communication with the hollow interior of the head portion. Three manual pumps are slidably disposed within the handle portion. Three tubes are removably disposed within the head portion and the handle portion disposed between the outlet ports of the head portion and the three pumps. The three tubes hold quantities of liquid toothpaste, mouthwash and antibacterial rinse.

U.S. Pat. No. 4,060,870 to Anthony Cannarella describes a dental appliance including a curved tubular extension consists of a housing formed with first and second elongated recesses, and first and second pumps secured to the housing for pumping a paste and a fluid directly through the first and second recesses, respectively. A flexible drive shaft is rotatably disposed within the curved tubular extension and one end of the drive shaft is operatively connected to an electric motor within the housing. The housing and the tubular extension formed thereon are divided into first and second portions, which may be separated along a plane substantially intersecting the longitudinal axis of the motor and that of the flexible shaft. A bearing rotatably supports the flexible shaft extending therethrough and secures the first and second portions of the tubular extension together. A toothbrush is drivably attached to the other end of the flexible shaft for rotating therewith. Upon actuation of the pumps, the paste and fluid are applied to an oral cavity containing teeth, and the teeth therein are cleaned by the toothbrush upon actuation of a switch energizing the motor and direct application of the toothpaste or liquid.

None of these prior art references describe the present invention.

### SUMMARY OF THE INVENTION

It is an object of the present invention to provide an all in one system for maintaining healthy dental hygiene on a daily basis.

### BRIEF DESCRIPTION OF THE DRAWINGS

FIG. 1 is an illustrative prototypical side view showing the components of the device of the present invention, including bristle brush for tooth brushing, tongue scraper, floss roll, and mouthwash spray.

FIG. 2 is an illustrative schematic front view showing the electrical component control panel which controls the functioning of the device.

FIG. 3 is an illustrative schematic side view showing the internal components of the present invention.

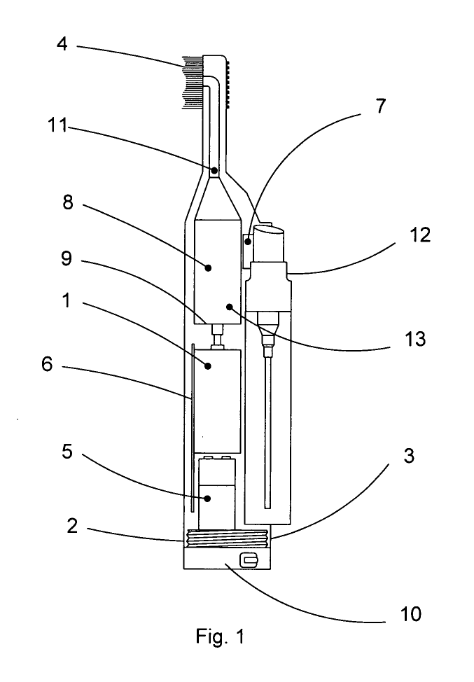

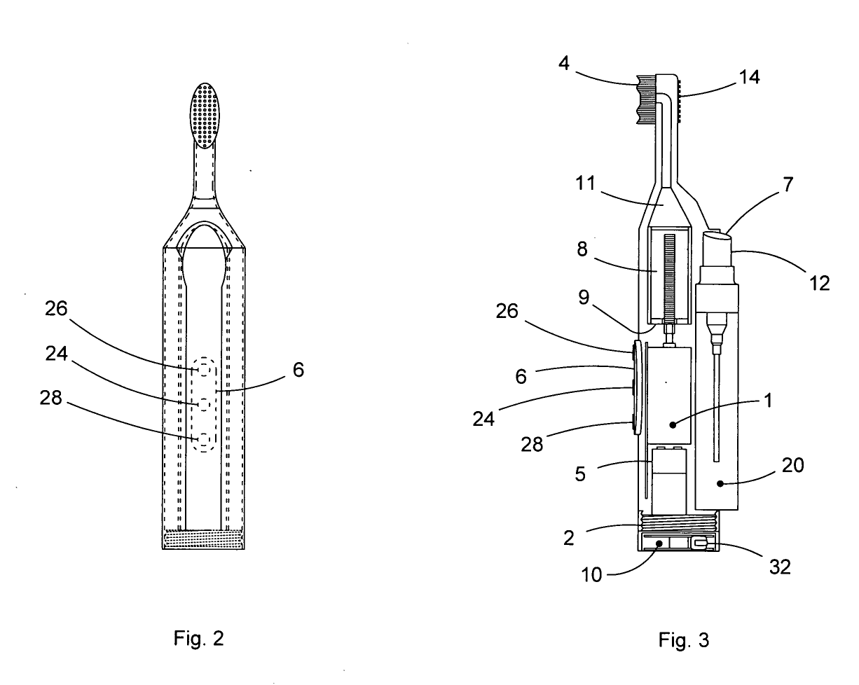

### DETAILED DESCRIPTION OF THE INVENTION

Brushing one's teeth is one of the most important parts of healthy hygiene. In addition to freshening one's breath and strengthening one's teeth, proper brushing kills germs and bacteria that grow inside the mouth. A common chronic childhood disease throughout the world is tooth decay. Adults suffer from various forms of dental disease that lead to painful oral surgeries and costly trips to a dentist. To have a healthy smile, people need to brush and floss their teeth at least twice daily, preferably after meals. This recommendation often proves to be easier said than done. With hustling and bustling around busy work and school days, it is impractical to cart around a toothbrush and a bulky messy tube of toothpaste. Consumers often find it difficult to brush their teeth after a lunch meeting or immediately following an afternoon snack. The longer food particles remain in one's mouth, the more susceptible teeth become to the formation of cavities and decay. Those consumers who are enjoying a busy day of shopping or travel face this dilemma as well. In the world of modern travel, luggage is a liability. For most travelers, the solution is to travel light with a laptop and carry-on bag that fits in the overhead compartment and contains the bare necessities for a few days away from home. There are a lot of essentials to be packed into a single bag. In order to practice aforementioned daily dental hygiene, an individual needs a toothbrush, toothpaste, a dispenser of dental floss and mouthwash. These four separate items take up space and are capable of leaking.

Please refer to the drawings. The present invention provides a solution to the aforementioned problems. The Multi-Functional Klassic Toothbrush is a compact, all in one system for maintaining a healthy dental hygiene on a daily basis. Incorporated within the unit is a vibrating replaceable toothbrush head 4, where toothpaste is electrically funneled onto the bristles. It also includes a tongue-scraper 14, a refillable reservoir of mouthwash 20 and a replaceable cartridge of dental floss 10.

The Multi-Functional Klassic Toothbrush resembles other electric toothbrushes in overall appearance, yet fully compact. The toothbrush heads are replaceable and will be offered in different versions of soft, medium and firm. The toothbrush measures 10¾ inches in length and 1¼ inch in width. It is powered by three AA rechargeable batteries, which are located in compartment 5, above the dental floss 10. The batteries supply power to primary motor 1 and vibrating motor 7. The reel of dental floss 10 will be securely screwed into the floss compartment 3, which is threaded into the internal base 2 of the toothbrush. On the exterior of the device where the floss is located, is a small floss cutter 32 for easy everyday use. Therefore, the floss roll 10 is stored in compartment 3, and used while in the base 2. Floss roll 10 will only need to be removed when the container is empty. Above the dental floss is a screw cap cartridge 20 for the mouthwash that is securely attached to the toothbrush. Attached to the 2 oz mouthwash cartridge is a sprayer 12 for everyday usage. Since the mouthwash cartridge 20 is snapped into a grove and the dental floss 10 is screwed onto the toothbrush base, both modules will only need to be removed to refill the content. The paste is stored in a receptacle in cylinder 8 which is next to the mouthwash cartridge 20 and below the toothbrush head 4; the toothpaste in the receptacle in cylinder 8 is also refillable.

The electrical component 6 controls the vibrating head and is housed directly below the toothbrush head 4 and in front of the toothpaste cylinder 8. There are three linearly arranged power buttons on the electrical component 6. The middle button 24 is the on/off controller for the vibrating motor 7 which activates vibration of toothbrush head 4. The additional 2 buttons control the functions of the toothpaste flow. When the toothpaste flow button 26 is activated, plunger plate 9 is raised thereby pushing toothpaste through tube 11 from the toothpaste receptacle in cylinder 8 to the bristles on the toothpaste head 4. The third button 28 is used to stop the flow of the toothpaste and also to assist in refilling the internal toothpaste cylinder.

The back of the brush head is configured as a tongue scraper 14. The Klassic is self contained and its reservoir capacities are within the volumes allowable on airline flights. The Multi Functional Klassic Toothbrush set includes toothpaste tube refills. Compact, self contained, battery powered and engineered for ease of use and superior dental hygiene, the Multi-Functional Klassic Toothbrush system eliminates cross contamination of germs, viruses and bacteria when members of a household use separate toothbrushes but the same toothpaste dispenser. Extremely functional, easily used and durably constructed, the Klassic will withstand years of repeated use.

The Klassic Toothbrush is dental hygiene maintenance made simple! It offers consumers the convenience of having all their dental hygienic products in one compact location. Consumers will no longer need to search for, nor will they forget any of their products. With its powerful vibrating head the Klassic Toothbrush will provide a superior dental cleaning when compared to a conventional toothbrush. This product will also be a huge benefit to those who travel and others who use their toothbrush in the office. A convenient reminder for the average household member to not just brush but in addition remind them to floss and cleanse their mouth. Consequently this will help to Reduce or eliminate a lot of gum disease such as gingivitis.

Although this invention has been described with respect to specific embodiments, it is not intended to be limited thereto and various modifications which become apparent to the person of ordinary skill in the art are intended to fall within the spirit and scope of the invention as described herein taken in conjunction with the accompanying drawings and the appended claims.

1. A multi functional toothbrush device comprising: a vibrating replaceable toothbrush head, refillable toothpaste receptacle, means for transferring toothpaste from receptacle to toothbrush head, tongue-scraper, refillable reservoir of mouthwash, and a replaceable cartridge of dental floss.

2. The multi-functional toothbrush device of claim 1, wherein the replaceable toothbrush heads comprise bristles in different versions including soft, medium and firm.

3. The multi-functional toothbrush device of claim 1, wherein the toothbrush measures approximately 10¾ inches in length and 1 and ¼ inch in width.

4. The multi-functional toothbrush device of claim 1, further comprising a vibrating motor wherein the vibrating motor moves the toothbrush head and the motor is powered by three AA rechargeable batteries.

5. The multi-functional toothbrush device of claim 1, wherein the cartridge of dental floss further comprises a reel of dental floss which is housed in a compartment, which is threaded into an internal base of the toothbrush.

6. The multi-functional toothbrush device of claim 5, further comprising a small floss cutter on the exterior of the device where the cartridge of floss is located.

7. The multi-functional toothbrush device of claim 1, wherein the mouthwash reservoir further comprises a screw cap cartridge for receiving mouthwash, wherein the mouthwash cartridge is situated above the dental floss compartment.

8. The multi-functional toothbrush device of claim 7, wherein the mouthwash reservoir further comprises a sprayer.

9. The multi-functional toothbrush device of claim 1, wherein the toothpaste receptacle is stored in a cylinder which is next to the mouthwash cartridge.

10. The multi-functional toothbrush device of claim 1, further comprising electrical component controls for controlling the vibrating toothbrush head and the flow of toothpaste, wherein the electrical component controls are situated directly below the toothbrush head and in front of the toothpaste cylinder.

11. The multi-functional toothbrush device of claim 10, wherein the electrical component controls include three linearly arranged buttons, wherein the first button activates the flow of toothpaste from the receptacle to the toothbrush head, the middle button is the on/off controller for the vibrating motor which activates vibration of toothbrush head, and the third button is used to stop the flow of the toothpaste and also to assist in refilling the internal toothpaste cylinder.

12. The multi-functional toothbrush device of claim 11, wherein the flow of toothpaste occurs when the first button is activated, thereby raising a plunger plate which pushes toothpaste through a tube from the toothpaste receptacle to the bristles on the toothbrush head.

13. The multi-functional toothbrush device of claim 1, wherein the back of the toothbrush head is configured as a tongue scraper.

14. The multi-functional toothbrush device of claim 1, wherein the toothpaste receptacle and mouthwash reservoir capacities are within the volumes allowable on airline flights.
